(19) United States
(12) Patent Application Publication
(10) Pub. No.: US 2002/0105899 A1
(43) Pub. Date: Aug. 8, 2002

(54) Digital media hangtag having a non circular contour

(76) Inventor: Shaw-Yueh Lin, San Diego, CA (US)

Correspondence Address: DANIEL ROBBINS, 3346A INDUSTRIAL COURT, SAN DIEGO, CA, 92121, US

(21) Appl. No.: 09/776,314

(22) Filed: Feb. 2, 2001

Related U.S. Application Data
(60) Provisional application No. 60/233,079, filed on Sep. 18, 2000.

(51) Int. Cl. G11B 3/70; G11B 5/84; G11B 7/26

(52) U.S. Cl. 369/272; 369/273

(57) ABSTRACT

A planar sheet, non circularly shaped digital media hangtag has a centrally positioned circular band adapted for storage and/or retrieving of digital data in the form of a CD/DVD recording. The disk has a centrally positioned hole the same as a standard CD/DVD, so the hangtag is compatible with transport on standard record/playback devices. Because the circular recording area of hangtag does not fill the entire recordable sheet, there are unrecordable regions of the hangtag. This permits a hole to be pierced through the disc in an unrecorded region that will not interfere with the recorded material, and allows the attachment of the hangtag to a product by a plastic filament threaded through the hole. To protect the recording surface, a plastic cover, which may also carry printed information, is glued to a non recording area at the cover's edges over the recording area. When attached to a product, the hangtag will hang in a vertical direction with the printed matter correctly oriented for reading without the necessity of rotation. A second hole through the disk provides usefulness by allowing a card carrying information to be suspended from the hangtag.

This application claims the benefit of U.S. Provisional Application Serial No. 60/233,079 filed Sep. 18, 2000.

### BACKGROUND OF THE INVENTION

1. Field of the Invention

This invention relates to product merchandising tags, and in particular to tags incorporating product oriented machine recordable and readable digital data.

2. Description Relative to the Prior Art

The use of paper printed tags for exhibiting merchandise price and merchandise related characteristics, such as size, color and material is well known in the art. Recently, a more sophisticated hangtag including such information encoded in digital media is disclosed in PCT application Ser. No. PCT/US00/03593, entitled “Product Registration System and Network-Ready Hangtag Usable Therewith”, filed by S. Y. Lin and R. Takashima, dated Feb. 11, 2000. This application is hereby incorporated by reference.

The above referenced application discloses a series of digital media related hangtags in the forms of CD-R, CD-ROM, CD-RW, DVD-R, DVD-RW, DVD-RAM, that utilize magnetic, magneto-optical, and optical media for storing digital data, as well as other digital memory devices such as flash memory for electronically storing data. Those storage devices that require relative motion between the media and relevant transducing elements are implemented as a circular disk or as a truncated circular disk embodying the media. The present invention discloses another digital media structure that provides novel and useful features not considered in the prior art.

### SUMMARY OF THE INVENTION

An example embodying the invention, is an elliptically shaped digital media hangtag having a centrally positioned circular band adapted for storage and/or retrieving of digital data in the form of a CD/DVD recording. The major axis of the ellipse is less than or equal to the diameter of a standard CD or DVD disc, and has a centrally positioned hole the same as a standard CD/DVD, so the elliptical hangtag is compatible with transport on standard record/playback devices. Using conventional data recording techniques, at least 60 megabytes of data may be stored on the circular band of the elliptical hangtag.

Because the circular recording area's diameter is less than the length of the minor axis of the elliptically shaped hangtag, there are unrecordable regions at each end of the hangtag along the direction of the major axis of the ellipse. This permits a hole to be pierced through the disc in an unrecorded region that will not interfere with the recorded material, and allows the attachment of the hangtag to a garment or other product by a plastic filament threaded through the hole. To protect the recording surface from dust or abrasion, a plastic cover, which may also carry price or other printed information, is glued at the cover's edges over the recording area. It will be appreciated that when attached to a garment or other product, the elliptical hangtag will hang in a vertical direction with the printed matter correctly oriented for reading by a customer without the necessity of rotating the tag for ease of reading.

A second hole through the disc, symmetrically located with respect to a first hole, provides additional usefulness to the elliptical hangtag. There are many merchandising situations where the price of an item is to be changed, usually in a downward direction, and this must be visibly indicated to a potential buyer on the price tag of, for example, a garment. Using the second hole through the hangtag, a paper or plastic card carrying the printed value of the changed price, along with an appropriate barcode, or a magnetic or flash card may be attached by a plastic filament to the hangtag. The auxiliary tag, which may be easily changed if more than one price change is required to move the goods, is now readable using a static reader without the necessity of relative rotary motion between the hangtag and a read transducer to access information directly from the hangtag itself. Upon sale of the item, the code read from the auxiliary tag allows access to relevant data stored in a central computer. This feature is useful even without a price change in simplifying the apparatus involved in processing a sale. However, the digital media hangtag itself remains the central merchandising tool with respect to interactive communications with the customer, as developed in detail in the application of Lin and Takashima referenced above.

### BRIEF DESCRIPTION OF THE DRAWINGS

The invention will be described with respect to the figures, of which:

FIG. 1 is a drawing a first embodiment of the invention, and

FIG. 2 is a drawing of a second embodiment of the invention.

### DESCRIPTION OF THE PREFERRED EMBODIMENTS

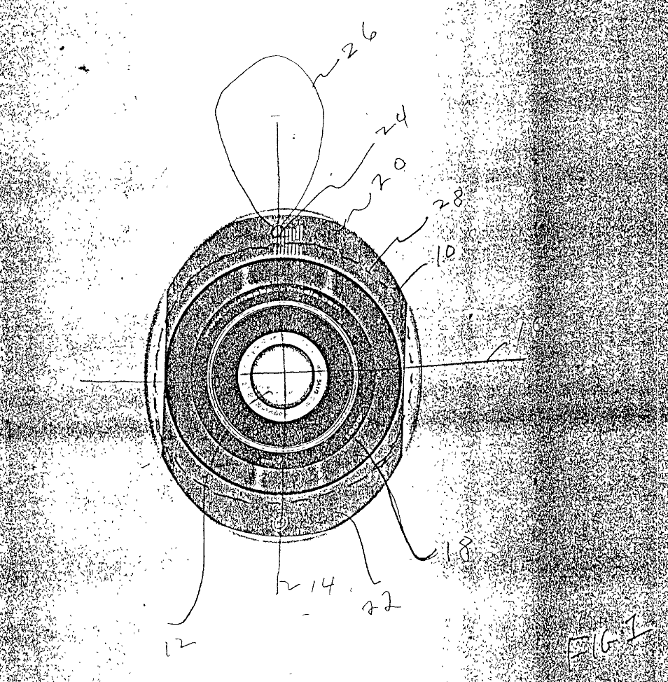

Referring to FIG. 1, an elliptically shaped hangtag CD/DVD disk 10 has a centrally located hole 12 compatible with standard CD/DVD recorder/reader spindle dimensions. The major axis of the disk 10 is along the direction 14, and the minor axis is along the direction 16. A centrally positioned circular band 18 defines a recordable region for CD/DVD recording. Due to the elliptical shape of the disk 10, regions 20, 22 remain available outside the circular band for use other than recording. A small hole 24 piercing the disk 10 has a plastic filament 26 threaded through it for use in attaching the hangtag CD/DVD disk 10 to a product. A plastic cover 28, capable of carrying a printed message, is glued at its edges over the circular band 18 to protect the recording region.

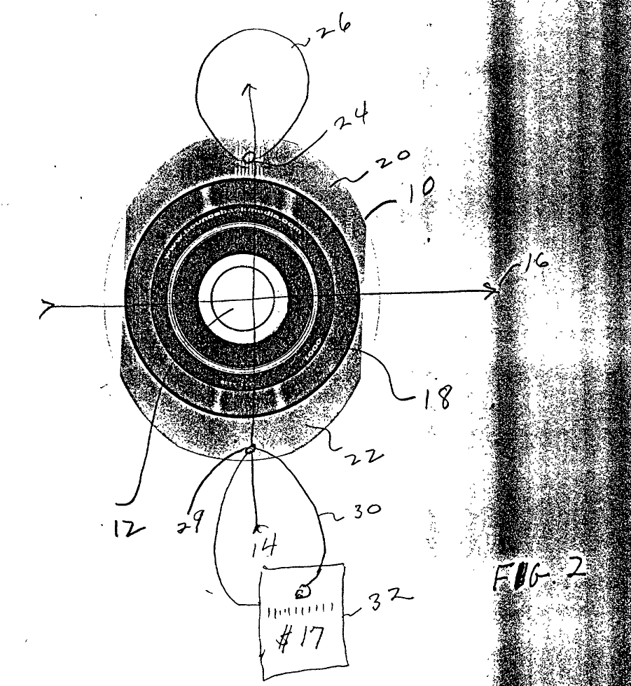

A second embodiment of the invention is shown in FIG. 2. The disk 10 as described above has a second hole 29 symmetrically placed relative to the hole 24 along the major axis 14. A plastic filament 30 through the hole 28 is attached to a tag 32. The tag 32 may be a printed tag having information that may be read by a static optical scanner, or a magnetic card readable by a static magnetoresistive transducer, or a flash memory card readable by static electronic reader. The read data from the tag 32 is input into a central computer for further processing of the sale of the item.

The invention has been described in detail with particular reference to preferred embodiments thereof, but it will be understood that variations and modifications can be effected within the spirit and scope of the invention. For example, the contour of the disk 10 may be non circular and other than elliptical in shape with the invention being practiced by employing a circular recording region and threading holes in the non recordable region of the disk, as disclosed above.

What is claimed is:

1. A recordable medium comprising:
a) a planar sheet having a non circular contour,
b) a mounting hole whereby said sheet may be positioned for rotation by a cooperative mechanical drive mechanism,
c) a first non recordable area of said sheet concentrically proximate to said mounting hole,
d) a ring shaped recordable area concentric with said mounting hole, said recording area contiguous to said first non recordable area,
e) a second non recordable area of said sheet distal to said ring shaped recording area, and
f) at least one aperture through said planar sheet, said at least one aperture located in said second non recordable area.

2. The recordable medium of claim 1 wherein said contour is elliptical.

3. The recordable medium of claim 1 wherein at least one flexible cord threads through said at least one aperture.

4. The recordable medium of claim 3 wherein said flexible cord forms a continuous loop.

5. A recordable medium comprising:
a) a planar sheet having a non circular contour,
b) a mounting hole whereby said sheet may be positioned for rotation by a cooperative mechanical drive mechanism,
c) a first non recordable area of said sheet concentrically proximate to said mounting hole,
d) a ring shaped recordable area concentric with said mounting hole, said recording area contiguous to said first non recordable area,
e) a second non recordable area of said sheet distal to said ring shaped recording area,
f) at least one aperture through said planar sheet, said at least one aperture located in said second non recordable area, and
g) a removable cover positioned over said recordable area, said removable cover edge fastened to said second non recordable area of said sheet, whereby said recordable area is protected by said removable cover.

6. The recordable medium of claim 5 wherein said contour is elliptical.

7. The recordable medium of claim 5 wherein at least one flexible cord threads through said at least one aperture.

8. The recordable medium of claim 7 wherein said flexible cord forms a continuous loop.

9. The recordable medium of claim 5 wherein said cover has a message printed thereon.

10. The recordable medium of claim 1 wherein said medium is a magnetic medium.

11. The recordable medium of claim 1 wherein said medium is an optical medium.

12. The recordable medium of claim 1 wherein said medium is a magneto-optical medium.

13. The recordable medium of claim 5 wherein said medium is a magnetic medium.

14. The recordable medium of claim 5 wherein said medium is an optical medium.

15. The recordable medium of claim 5 wherein said medium is a magneto-optical medium.
